(19) United States
(12) Patent Application Publication
(10) Pub. No.: US 2012/0050904 A1
(43) Pub. Date: Mar. 1, 2012

(54) METHOD AND APPARATUS FOR COMPENSATING FOR DISTURBANCE AND DISK DRIVE EMPLOYING THE SAME

(75) Inventors: Sung-won PARK, Seoul (KR); Soo-il CHOI, Yongin-si (KR); Jae-sang YUN, Seoul (KR)

(73) Assignee: SAMSUNG ELECTRONICS CO., LTD., Suwon-si (KR)

(21) Appl. No.: 13/216,813

(22) Filed: Aug. 24, 2011

(30) Foreign Application Priority Data
Aug. 24, 2010 (KR) 10-2010-0082087

(51) Int. Cl. G11B 27/36; G11B 21/02; G11B 33/14

(52) U.S. Cl. 360/31; 360/97.02; 360/75; G9B/33.035; G9B/27.052

(57) ABSTRACT

A method and apparatus for compensating for a disturbance by detecting a periodic external disturbance applied to a data storage apparatus is provided. The method includes: calculating a correlation coefficient for a first signal corresponding to a first period and a second period that is adjacent to the first period generated from a servo control system of a data storage apparatus; estimating a disturbance of a third period by using the first signal of the first period; determining whether a periodic external shock is generated based on the calculated correlation coefficient; and if it is determined that the periodic external shock is generated, compensating for the disturbance to be generated in the third period by feed-forwarding the estimated disturbance of the third period to the servo control system.

### CROSS-REFERENCE TO RELATED APPLICATION

This application claims the benefit of Korean Patent Application No. 10-2010-0082087, filed on Aug. 24, 2010, in the Korean Intellectual Property Office, the disclosure of which is incorporated herein in its entirety by reference.

### BACKGROUND

Methods and apparatuses consistent with the exemplary embodiments relate to a method and apparatus for compensating for a disturbance, and more particularly, to a method and apparatus for compensating for a disturbance by detecting a periodic external disturbance applied to a data storage medium.

A disk drive, which is one of many data storage apparatuses, rotates a disk by using a spindle motor and writes data to a disk or reads data from a disk by using a head. When an external shock synchronized with a rotational period of the disk is applied, reading or writing of data may be adversely affected. Accordingly, research into detection and compensation for an external shock synchronized with a rotational period of a disk is required.

### SUMMARY

One or more exemplary embodiments provide a method of compensating for a disturbance by detecting a periodic external disturbance applied to a system using a feed-forward method.

One or more exemplary embodiments also provide an apparatus for compensating for a disturbance by detecting a periodic external disturbance applied to a system using a feed-forward method.

One or more exemplary embodiments also provide a disk drive employing a method of compensating for a disturbance by detecting a periodic external disturbance applied to a system using a feed-forward method.

According to an aspect of an exemplary embodiment, there is provided a method of compensating for a disturbance, the method including: calculating a correlation coefficient for a first signal in adjacent periods generated from a servo control system of a data storage apparatus; estimating a disturbance of a next period by using the first signal of a previous period; determining whether a periodic external shock is generated based on the calculated correlation coefficient; and when it is determined that the periodic external shock is generated, compensating for the disturbance to be generated in the next period by feed-forwarding the estimated disturbance of the next period to the servo control system.

The first signal may include a position error signal.

The servo control system may control a movement of a head of a disk drive.

The calculating of the correlation coefficient may be performed in a retry mode or an idle mode.

The calculating of the correlation coefficient may be performed when the first signal is abnormally detected in a retry mode of a disk drive.

The correlation coefficient COR(x,y) may be calculated according to

$$COR ( x , y ) = \frac{{σ}_{xy}}{\sqrt{{σ}_{xx} {σ}_{yy}}}$$

and σ_{xy} may be a covariance for the first signal in a k^{th} period (k is a fixed number greater than or equal to 1) and a k+1^{th} period, and σₓₓ and σ_{yy} may be variances for the first signal in the k^{th} period and the first signal in the k+1^{th} period, respectively.

The estimating of the disturbance may include multiplying an inverse transfer function between an input disturbance and the first signal by the first signal of the previous period and calculating an estimated disturbance of the next period.

The estimating of the disturbance may include subtracting a control signal of the servo control system from the value obtained by multiplying an inverse transfer function of a plant targeted to be controlled by the servo control system by the first signal of the previous period and calculating an estimated disturbance of the next period.

The inverse transfer function may be calculated after obtaining a transfer function having a zero phase error tracking (ZPET) characteristic and additionally using a finite impulse response (FIR) filter.

The determining of whether the periodic external shock is generated may include calculating at least one of currently calculated correlation coefficients, average values of the correlation coefficients in continuously adjacent periods, accumulation values of the correlation coefficients in an initially set period, the maximum value of the correlation coefficients, and the minimum value of the correlation coefficients and determining that the periodic external shock is generated when the calculated value exceeds an initially set threshold value.

The method may further include performing evaluation related to control performance of the servo control system before and after the disturbance compensation by the feed-forward. As a result of the evaluation, if the control performance of the servo control system after being feed-forwarded is not improved compared with before being feed-forwarded, the estimating of the disturbance is retried.

According to an aspect of another exemplary embodiment, there is provided an apparatus for compensating for a disturbance, the apparatus including: a plant for generating a position error signal that corresponds to a final control signal; a servo controller for generating a control signal for controlling the plant based on an input signal; a feed-forward input generating unit for calculating an estimated disturbance of a next period by using a position error signal of a previous period in a disturbance detection mode, calculating a correlation coefficient of the position error signal in adjacent periods, and outputting the calculated estimated disturbance when the calculated correlation coefficient exceeds a threshold value; and a subtractor for subtracting the estimated disturbance output from the feed-forward input generating unit from the control signal generated from the servo controller and applying the subtracted value to the plant.

The feed-forward input generating unit may include: a buffer unit for temporarily storing information; a first operator for calculating a correlation coefficient of a position error signal of the previous period stored in the buffer unit and an input position error signal of a current period; a second operator for calculating an estimated disturbance by multiplying an inverse transfer function between an input disturbance applied to the plant and a position error signal generated from the plant by the position error signal of the previous period stored in the buffer unit; and a disturbance compensation controller for storing a position error signal corresponding to at least one period in a disturbance detection mode and the calculated estimated disturbance in the buffer unit and outputting the estimated disturbance stored in the buffer unit to the subtractor, when the calculated correlation coefficient exceeds a threshold value.

The feed-forward input generating unit may include: a buffer unit for temporarily storing information; a first operator for calculating a correlation coefficient of a position error signal of the previous period stored in the buffer unit and an input position error signal of a current period; a third operator for calculating an estimated disturbance by subtracting a control signal of the previous period stored in the buffer unit from a value obtained by multiplying an inverse transfer function of the plant by the position error signal of the previous period stored in the buffer unit; and a disturbance compensation controller for storing a position error signal, a control signal corresponding to at least one period in a disturbance detection mode, and the calculated estimated disturbance in the buffer unit and outputting the estimated disturbance stored in the buffer unit to the subtractor, when the calculated correlation coefficient exceeds a threshold value.

The apparatus may further include a finite impulse response (FIR) filter that low pass filters the estimated disturbance and wherein the inverse transfer function is realized as a transfer function having a zero phase error tracking (ZPET) characteristic.

The plant may include an actuator driving device for moving a head of a disk drive.

According to another aspect of an exemplary embodiment, there is provided a disk drive including: a disk for storing information; a head for writing information to the disk or reading information from the disk; an actuator driving device for moving a head on the disk according to an input signal and generating a position error signal that corresponds to a movement of the head; a servo controller for generating a control signal for controlling a movement of the head based on the position error signal; a feed-forward input generating unit for calculating an estimated disturbance of a next period by using a position error signal of a previous period in a disturbance detection mode, calculating a correlation coefficient of the position error signal in adjacent periods, and outputting the calculated estimated disturbance when the calculated correlation coefficient exceeds a threshold value; and a subtractor for subtracting the estimated disturbance output from the feed-forward input generating unit from the control signal generated from the servo controller and applying the subtracted value to the actuator driving device.

The feed-forward input generating unit may include: a buffer unit for temporarily storing information; a first operator for calculating a correlation coefficient of a position error signal of the previous period stored in the buffer unit and an input position error signal of a current period; a second operator for calculating an estimated disturbance by multiplying an inverse transfer function between an input disturbance applied to the plant and a position error signal generated from the plant by the position error signal of the previous period stored in the buffer unit; and a disturbance compensation controller for storing a position error signal corresponding to at least one period in a disturbance detection mode and the operated estimated disturbance in the buffer unit and outputting the estimated disturbance stored in the buffer unit to the subtractor, when the operated correlation coefficient exceeds a threshold value.

The feed-forward input generating unit may include: a buffer unit for temporarily storing information; a first operator for calculating a correlation coefficient of a position error signal of a previous period stored in the buffer unit and an input position error signal of a current period; a third operator for calculating an estimated disturbance by subtracting a control signal of the previous period stored in the buffer unit from the value obtained by multiplying an inverse transfer function of the actuator driving device by the position error signal of the previous period stored in the buffer unit; and a disturbance compensation controller for storing a position error signal, a control signal corresponding to at least one period in a disturbance detection mode, and the operated estimated disturbance in the buffer unit and outputting the estimated disturbance stored in the buffer unit to the subtractor, when the operated correlation coefficient is evaluated and it is determined that the disturbance is generated due to a periodic external shock.

### BRIEF DESCRIPTION OF THE DRAWINGS

Exemplary embodiments will be more clearly understood from the following detailed description taken in conjunction with the accompanying drawings in which:

FIG. 1 is a block diagram of a data storage apparatus, according to an exemplary embodiment;

FIG. 2 is a block diagram illustrating an operating system of the data storage apparatus of FIG. 1;

FIG. 3 is a plan view of a head disk assembly of a disk drive, according to an exemplary embodiment;

FIG. 4 is a block diagram illustrating an electric structure of the disk drive of FIG. 3;

FIG. 5 illustrates a sector of a track in a disk as a recording medium applied to an exemplary embodiment;

FIG. 6 illustrates a servo information area of FIG. 5;

FIG. 7 is a block diagram of a servo control system for generating a feed-forward input, according to an exemplary embodiment;

FIG. 8 is a block diagram of a servo control system for generating a feed-forward input, according to another exemplary embodiment;

FIG. 9 is a circuit-block diagram of an apparatus for compensating for a disturbance, according to an exemplary embodiment;

FIG. 10 is a circuit-block diagram of an apparatus for compensating for a disturbance, according to another exemplary embodiment;

FIG. 11 is a block diagram of a feed-forward input generator of FIG. 9;

FIG. 12 is a block diagram of a feed-forward input generator of FIG. 10;

FIG. 13 is a flowchart illustrating a method of compensating for a disturbance, according to an exemplary embodiment;

FIG. 14 is a flowchart illustrating a method of compensating for a disturbance, according to another exemplary embodiment;

FIG. 15 is a flowchart illustrating a method of compensating for a disturbance employing a method of generating a feed-forward input suggested in FIG. 7;

FIG. 16 is a flowchart illustrating a method of compensating for a disturbance employing a method of generating a feed-forward input suggested in FIG. 8;

FIG. 17 is a graph showing frequency response against Gv and Gv⁻¹ zero point error tracking (ZPET) in an actual disk drive; and

FIG. 18 is a graph showing frequency response against Gv*Gv⁻¹(ZPET) in an actual disk drive.

### DETAILED DESCRIPTION OF THE EXEMPLARY EMBODIMENTS

Exemplary embodiments will be described in more detail with reference to the accompanying drawings. The inventive concept may, however, be embodied in many different forms and should not be construed as being limited to the exemplary embodiments set forth herein; rather, these exemplary embodiments are provided so that this disclosure will be thorough and complete, and will fully convey the concept of the inventive concept to those skilled in the art. In the drawings, like reference numerals denote like elements.

Hereinafter, exemplary embodiments will be described more fully with reference to the accompanying drawings.

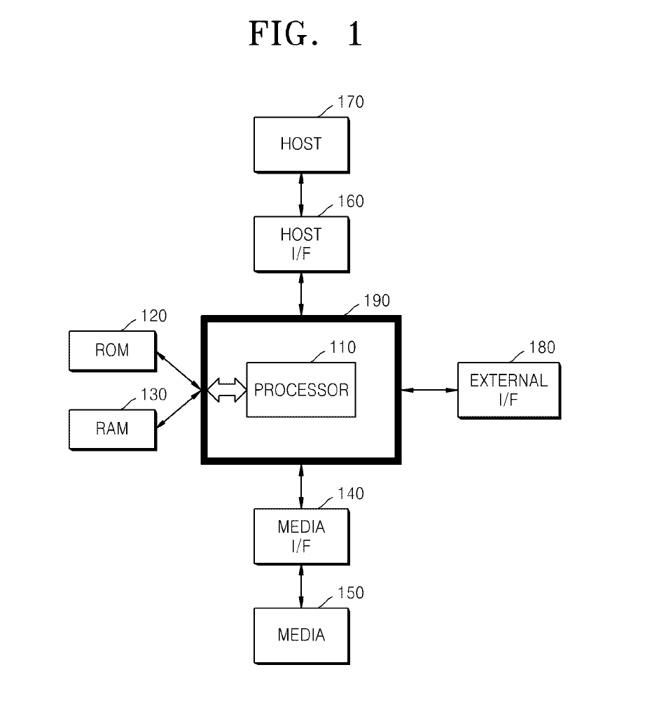

FIG. 1 is a block diagram of a data storage apparatus, according to an exemplary embodiment. Referring to FIG. 1, the data storage apparatus according to the current exemplary embodiment includes a processor 110, a read only memory (ROM) 120, a random access memory (RAM) 130, a media interface (I/F) 140, a media 150, a host I/F 160, a host 170, an external I/F 180, and a bus 190.

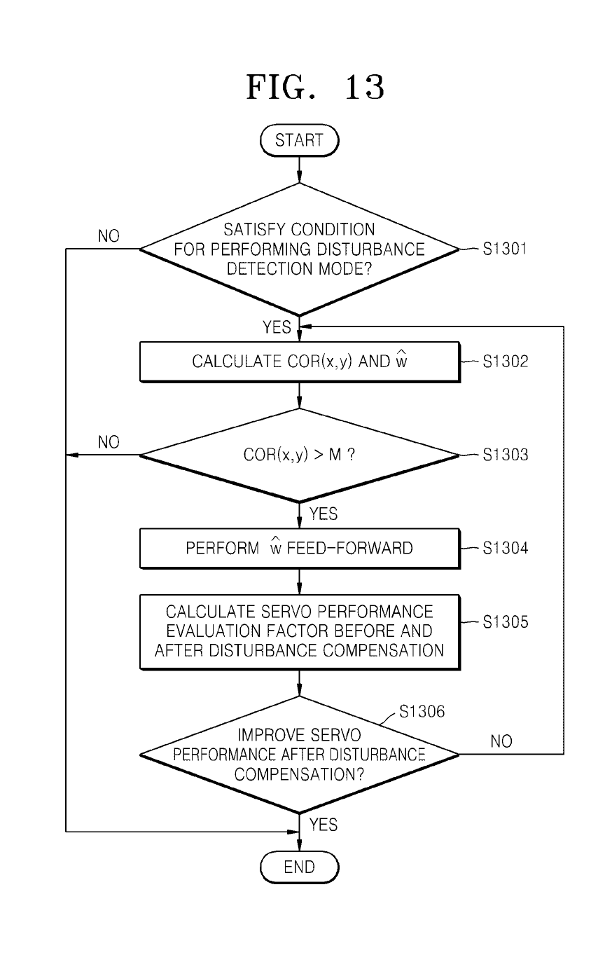

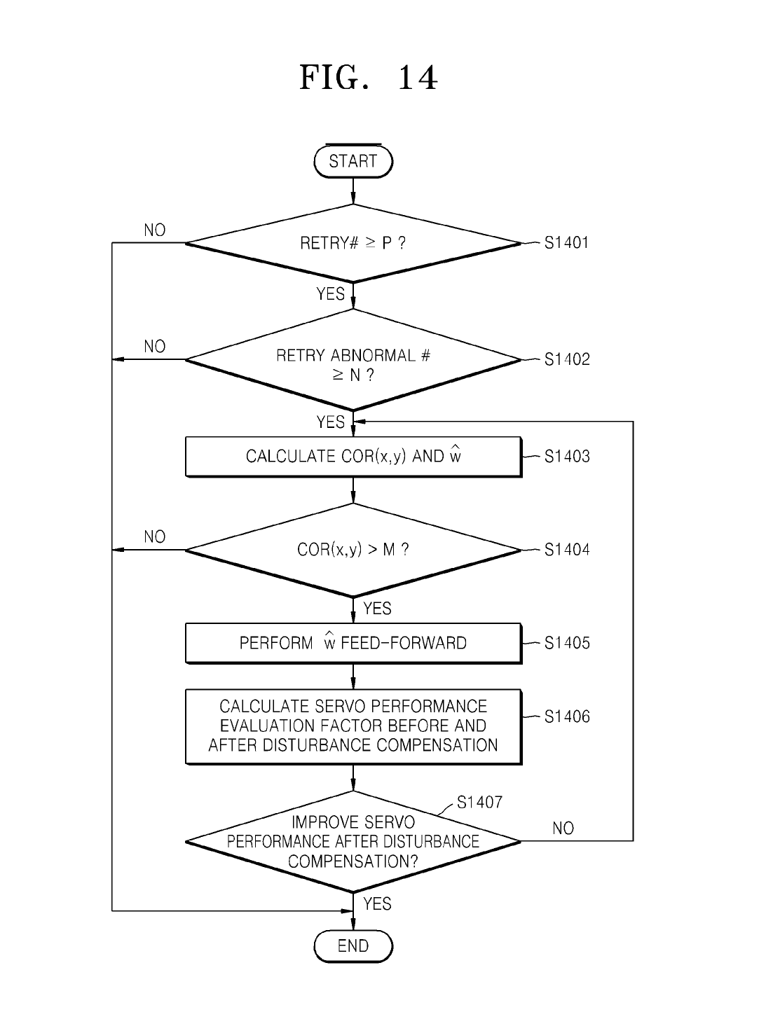

The processor 110 interprets commands and controls elements of the data storage apparatus according to the result of interpretation. The processor 110 includes a code object management unit (not shown) and loads a code object stored in the media 150 to the RAM 130 by using the code object management unit. The processor 110 loads code objects used to execute methods of compensating for a disturbance to the RAM 130. For example, processor 110 may load code objects used to execute the methods shown in FIGS. 13 through 16, which will be described in more detail below.

Then, the processor 110 performs a task for controlling a motor by using the code objects loaded to the RAM 130 and stores information required to execute the methods of compensating for a disturbance in the media 150 or the ROM 120. Examples of the information required to execute the methods of compensating for a disturbance may include various threshold values used to detect a disturbance and to determine a periodic disturbance.

Methods of compensating for a disturbance by detecting a periodic disturbance that may be executed by the processor 110 will be described in detail with reference to FIGS. 13 through 16.

The ROM 120 or the media 150 stores therein program codes and data required to operate the data storage apparatus.

The program codes and data stored in the ROM 120 or the media 150 are loaded to the RAM 130 according to a control of the processor 110.

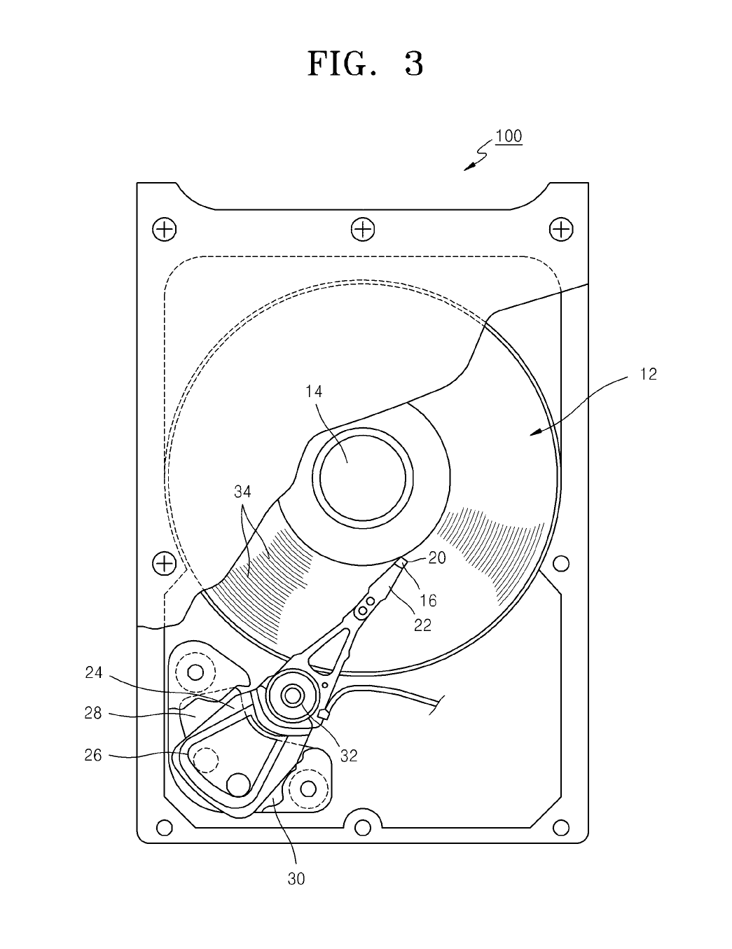

The media 150 is a main storage medium of the data storage apparatus and may include a disk. The data storage apparatus may include a disk drive, and a head disk assembly 100 included in the disk drive and including a disk and a head is illustrated in detail in FIG. 3.

Referring to FIG. 3, the head disk assembly 100 includes at least one disk 12 that rotates according to a spindle motor 14. The disk drive also includes a head 16 disposed adjacent to surfaces of the disks 12.

The head 16 may read or write information from or to the disks 12 by sensing magnetic fields of the disks 12 or by magnetizing the disks 12. In general, the head 16 is associated with each surface of the disks 12. Although only one head 16 is illustrated, it should be understood that the head 16 separately includes a head for writing used to magnetize the disks 12 and a head for reading used to sense the magnetic fields of the disks 12. The head for reading is formed of a magneto-resistive (MR) element. The head 16 may be called a magnetic head or a transducer.

The head 16 may be integrated with a slider 20. The slider 20 generates an air bearing between the head 16 and the disks 12. The slider 20 is combined to a head gimbal assembly 22. The head gimbal assembly 22 is attached to an actuator arm 24 including a voice coil 26. The voice coil 26 is disposed adjacent to a magnetic assembly 28 so as to define a voice coil motor (VCM) 30. A current supplied to the voice coil 26 generates a torque that rotates the actuator arm 24 against a bearing assembly 32. The actuator arm 24 rotates across the disks 12 so as to rotate the head 16.

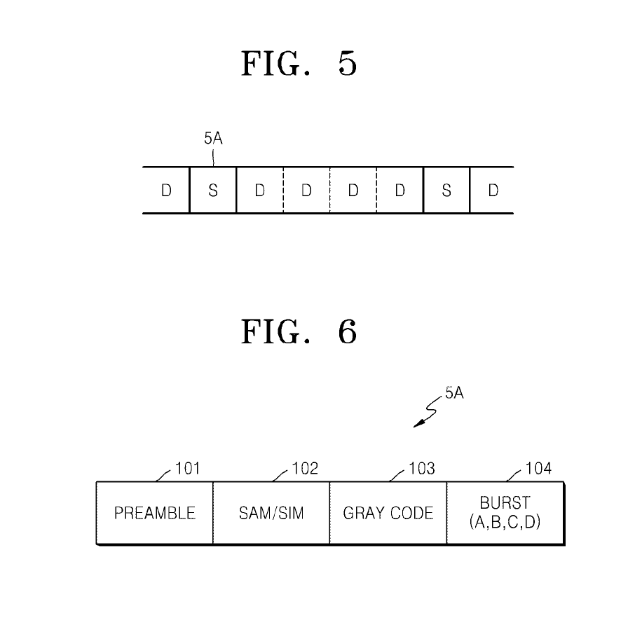

In FIG. 3, information is generally stored in annular tracks 34 of the disks 12. Each track 34 may generally include a plurality of sectors. A structure of sectors in a track is illustrated in FIG. 5.

As illustrated in FIG. 5, one track includes servo information fields S to which servo information is written and data sectors D in which data is stored. A plurality of the data sectors D may be included between the servo information fields S. Also, a single data sector D may be included between the servo information fields S. Signals as illustrated in FIG. 6 are written in a servo information field 5A.

As illustrated in FIG. 6, a preamble 101, a servo synchronization indicating signal 102, a gray code 103, and a burst signal 104 are written to the servo information field 5A.

The preamble 101 provides clock synchronization for reading servo information and provides a regular timing margin by having a gap in front of a servo sector. Also, the preamble 101 is used to determine a gain of an automatic gain control (AGC) circuit.

The servo synchronization indicating signal 102 includes a servo address mark (SAM) and a servo index mark (SIM). The SAM indicates a start of a sector and the SIM indicates a start of a first sector in a track.

The gray code 103 provides track information and the burst signal 104 is used to control the head 16 to follow a center of a track. The burst signal 104 may be formed of, for example, four patterns including A, B, C, and D and the four burst patterns are combined to generate a position error signal (PES) used to control track following.

Referring back to FIG. 3, a logic block address is allocated to a writable area of the disks 12. In the disk drive, the logic block address is converted into cylinder/head/sector information to designate a write area of the disks 12. The disks 12 are divided into a maintenance cylinder area, that is, an area that a user may not access, and a user data area, that is, an area that a user may access. The maintenance cylinder area may be referred to as a system area. Various information required to control the disk drive are stored in the maintenance cylinder area, in addition to information required to detect a disturbance and to process compensation.

The head 16 moves across the surfaces of the disks 12 in order to read or write information in different tracks. A plurality of code objects used to realize various functions of the disk drive may be stored in the disks 12. For example, a code object for executing an MP3 player function, a code object for executing a navigation function, a code object for executing various video games, and the like may be stored in the disks 12.

Referring back to FIG. 1, the media UF 140 allows the processor 110 to access the media 150 so as to write or read information. The media UF 140, realized as a disk drive, in the data storage apparatus includes a servo circuit that controls the head disk assembly 100 and a read/write channel circuit that executes signal processing for data reading/writing.

The host I/F 160 communicates data with the host 170, which may be a personal computer, and may include, for example, various standard interfaces such as a serial advanced technology attachment (SATA) interface, a parallel advanced technology attachment (PATA) interface, a universal serial bus (USB) interface, and the like.

The external I/F 180 communicates data with an external device through an input/output terminal installed to the data storage apparatus and may include, for example, various standard interfaces such as an accelerated graphics port (AGP) interface, a USB interface, an IEEE 1394 interface, a personal computer memory card international association (PCMCIA) interface, a LAN interface, a Bluetooth interface, a high definition multimedia interface (HDMI), a programmable communication interface (PCI), an industry standard architecture (ISA) interface, a peripheral component interconnect-express (PCI-E) interface, an express card interface, a SATA interface, a PATA interface, a serial interface, and the like.

The bus 190 communicates information with elements of the data storage apparatus.

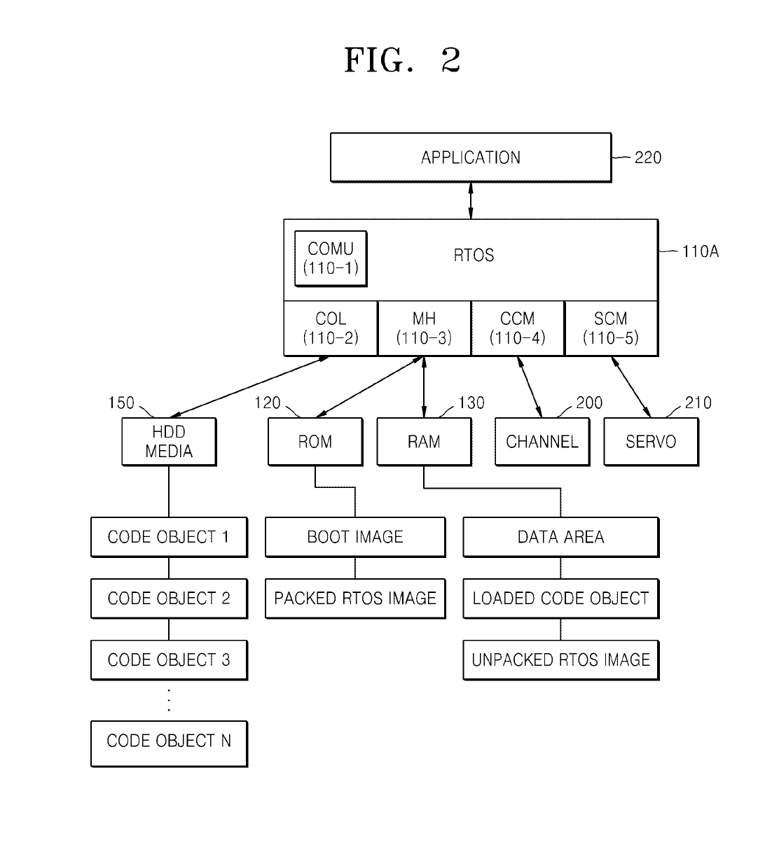

A software operating system of a hard disk drive (HDD) as the data storage apparatus of FIG. 1 will now described with reference to FIG. 2.

As illustrated in FIG. 2, the media 150 of the HDD stores a plurality of code objects 1 through N.

The ROM 120 stores a boot image and a packed real time operating system (RTOS) image.

The plurality of code objects 1 through N are stored in the media 150 of the HDD, which may be a disk. The code objects stored in the disk may include code objects required to operate the disk drive and code objects related to expanding various functions. In particular, code objects for executing the methods of compensating a disturbance of FIGS. 13 through 16 are stored in the disk. Also, the code objects for executing the methods of compensating a disturbance of FIGS. 13 through 16 may be stored in the ROM 120, instead of the media 150 of the HDD. In addition, code objects for executing various functions such as an MP3 player function, a navigation function, and video games may be stored in the disk.

The RAM 130 reads the boot image from the ROM 120 while booting the disk drive and an unpacked RTOS image is loaded to the RAM 130. Also, code objects required to operate a host I/F and external I/F stored in the media 150 of the HDD are loaded to the RAM 130. In the RAM 130, a data area for storing data is allocated.

In a channel circuit 200, circuits required to process signals for reading/writing data are included. In a servo circuit 210, circuits required to control the head disk assembly 100 are included to read/write data.

An RTOS 110a is a real time operating system program and is a multi-program operating system using a disk. In the RTOS 110a, real time multi processing is performed as a foreground process having high priority and batch processing is performed as a background process having low priority. Also, the RTOS 110a loads code objects from the disk and loads code objects onto the disk.

The RTOS 110a manages a code object management unit (COMU) 110-1, a code object loader (COL) 110-2, a memory handler (MH) 110-3, a channel control module (CCM) 110-4, and a servo control module (SCM) 110-5 so as to perform a task according to a requested command. The RTOS 110a also manages application programs 220.

In detail, the RTOS 110a loads code objects required to control the disk drive while booting the disk drive to the RAM 130. Accordingly, the code objects loaded to the RAM 130 are used to operate the disk drive after the booting process.

The COMU 110-1 stores location information regarding locations to which code objects are written, converts a virtual address into an actual address, and arbitrates a bus. Also, the COMU 110-1 stores information regarding priorities of performed tasks. In addition, the COMU 110-1 manages task control block (TCB) information required to execute tasks for code objects, and stack information.

The COL 110-2 loads the code objects stored in the HDD media 150 to the RAM 130 by using the COMU 110-1 and unloads the code objects stored in the RAM 130 to the HDD media 150. Accordingly, the COL 110-2 may load the code objects stored in the HDD media 150 used to execute the methods of compensating for a disturbance of FIGS. 13 through 16 to the RAM 130.

The RTOS 110a may execute the methods of compensating for a disturbance of FIGS. 13 through 16 by using the code objects loaded to the RAM 130.

The MH 110-3 writes or read data to or from the ROM 120 and the RAM 130.

The CCM 110-4 performs a channel control required to process signals for reading/writing data, and the SCM 110-5 performs a servo control required to operate the head disk assembly for reading/writing data.

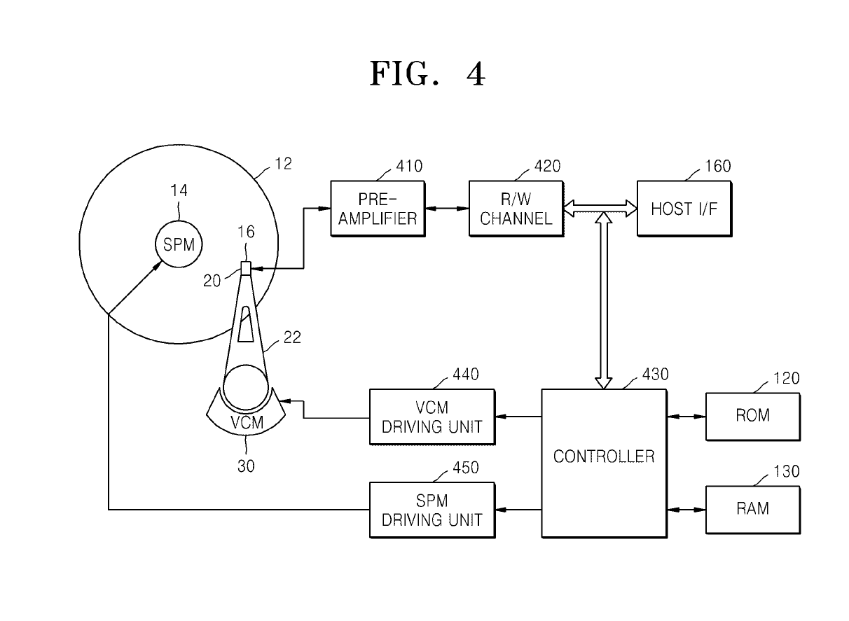

An electric structure of the disk drive of the data storage apparatus of FIG. 1 is illustrated in FIG. 4.

As illustrated in FIG. 4, the disk drive according to the current exemplary embodiment includes a pre-amplifier 410, a read/write (R/W) channel 420, a controller 430, a VCM driving unit 440, a spindle motor (SPM) driving unit 450, the ROM 120, the RAM 130, and the host I/F 160.

The controller 430 may be a digital signal processor (DSP), a microprocessor, a microcontroller, or a processor. The controller 430 controls the R/W channel 420 in order to read information from the disks 12 or write information to the disks 12 according to a command received from a host through the host OF 160.

The controller 430 is connected to the VCM driving unit 440. The VCM driving unit 440 supplies a driving current to drive the VCM 30. The controller 430 provides a control signal to the VCM driving unit 440 in order to control a movement of the head 16.

The controller 430 is also connected to the SPM driving unit 450. The SPM driving unit 450 supplies a driving current to drive the SPM 14. When power is supplied to the controller 430, the controller 430 provides a control signal to the SPM driving unit 450 in order to rotate the SPM 14 at a target speed.

The controller 430 is also connected to the ROM 120 and the RAM 130. Firmware and control data used to control the disk drive are stored in the ROM 120. Also, program codes and information used to execute the methods of compensating for a disturbance of FIGS. 13 through 16 may be stored in the ROM 120. In addition, program codes and information used to execute the methods of compensating for a disturbance of FIGS. 13 through 16 may be stored in the maintenance cylinder area of the disk 12, instead of the ROM 120.

Also, the controller 430 may detect a periodic disturbance according to the methods of FIGS. 13 through 16 by using the program codes and information stored in the ROM 120 or the maintenance cylinder area of the disk 12 and may process a signal used to compensate for the detected periodic disturbance.

Here, general data reading and data writing operations in the disk drive are described.

In a data read mode, the disk drive amplifies an electric signal sensed from the disks 12 through the head 16 in the pre-amplifier 410. Then, the signal output from the pre-amplifier 410 is amplified according to an AGC circuit (not illustrated) that automatically varies a gain based on intensity of a signal in the R/W channel 420. The amplified signal is converted into a digital signal, and then the digital signal is decoded, thereby detecting data. An error correction process is performed on the detected data by using a Reed-Solomon code as an error correction code in the controller 430 and then the data is converted into stream data. Then, the stream data is transmitted to the host through the host I/F 160.

In a data write mode, the disk drive receives data from the host through the host I/F 160, provides an error correction symbol such as a Reed-Solomon code in the controller 430, encodes the data into a form appropriate for a write channel in the R/W channel circuit 420, and writes the data to the disk 12 through the head 16 using a write current amplified in the pre-amplifier 410.

Next, a method of compensating for a disturbance according to an exemplary embodiment that may be executed in a disk drive will be described in detail. For convenience of description, the method of compensating for a disturbance is applied to a servo control system that controls a movement of a head in the disk drive. It is obvious that the method of compensating for a disturbance according to the exemplary embodiment is not limited to the servo control system and may be applied to location control used in products other than the disk drive.

Firstly, disturbance detection and compensation principle suggested in the exemplary embodiment are described.

When an external shock is applied to the disk drive, an error signal significantly varies at first and then residual vibrations gradually subside. When such an external shock is continuously applied in synchronization with a rotation period of the disk, a significant characteristic variation of a PES in a specific sector repeatedly appears with each rotation of the disk. In the exemplary embodiment, in order to detect and compensate for the periodic disturbance, detection of the periodic disturbance by using periodicity of the PES and compensation in a feed-forward form are suggested.

A disturbance detection mode in the exemplary embodiment may be designed to be performed in a retry mode or an idle mode. For example, when the PES is abnormally detected in the retry mode, the disturbance detection mode may be performed. More specifically, when the retry mode is performed for more than P times and the PES is abnormally detected for more than N times while the retry mode is performed for more than P times, the disturbance detection mode may be performed. However, the condition for performing the disturbance detection mode may be set differently from the above. Here, P and N are each a fixed number greater than or equal to 1, and are initially set values determined while designing the disk drive. The PES is abnormally detected when the intensity of the PES exceeds a threshold value TH1.

When the condition for performing the disturbance detection mode is satisfied, a correlation coefficient COR (x, y) for the PES corresponding to R (R>1) adjacent rotation periods is calculated as represented by Equation 1 and thus a periodic disturbance is determined.

$$COR ( x , y ) = \frac{{σ}_{xy}}{\sqrt{{σ}_{xx} {σ}_{yy}}} \qquad [ Equation 1 ]$$

Here, σₓₓ is a variance for the PES generated during one rotation of the disk in a k^{th} period, σ_{yy} is a variance for the PES generated during one rotation of the disk in a k+1^{th} period, and σ_{xy} is a covariance for the PES in the k^{th} period and the PES in the k+1^{th} period.

For reference, the covariance σ_{xy} is represented by Equation 2 below.

$${σ}_{xy} = \frac{1}{N} {\sum }_{i = 1}^{N} x ( i ) * y ( i ) \qquad [ Equation 2 ]$$

Here, x(i) is a PES value in the k^{th} period, y(i) is a PES value in the k+1^{th} period, and N is the number of sectors in one period.

When a correlation coefficient is calculated once and exceeds a predetermined threshold value M, it is determined as a disturbance by a periodic external shock. Also, when a correlation coefficient is calculated for a plurality of rotation periods, the correlation coefficients are averaged, and if the average exceeds the threshold value M, it may be determined as a disturbance by a periodic external shock. In addition, in order to determine periodicity, a condition may be added, in which sectors that generate the maximum value of the PES for each rotation period are compared to determine whether the PES repeats during R rotation periods.

When it is determined that a disturbance is generated due to a periodic external shock, a principle of generating a feed-forward input for compensating for the periodic disturbance is described.

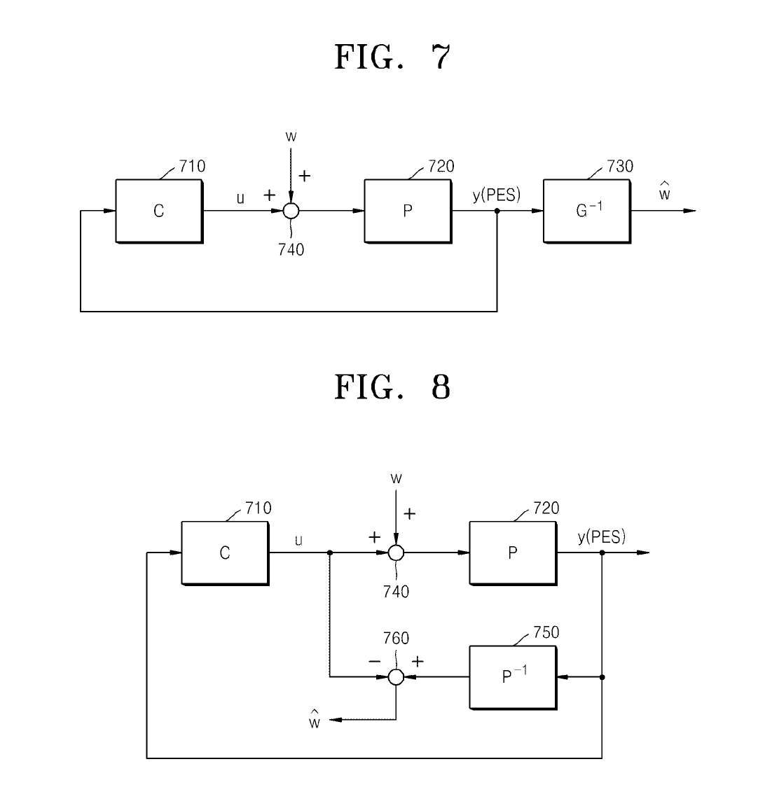

FIG. 7 is a block diagram of a servo control system for generating a feed-forward input, according to an exemplary embodiment.

As illustrated in FIG. 7, the servo control system according to the current exemplary embodiment for generating a feed-forward input includes a servo controller 710, a plant 720, a disturbance inverse transfer function tool 730, and a summer 740.

Here, the summer 740 indicates that a disturbance w is applied to the plant 720 due to an external shock.

The servo controller 710 estimates position, speed, and bias values from a servo output signal y of the plant 720 and a previous control signal u(k−1) to perform track following control in the disk drive and outputs a next control signal u(k) according to the estimated position, speed, and the bias values. In a track following mode, the servo output signal y generated from the plant 720 may be a position error signal (PES).

The plant 720 is a device to be servo controlled and may be an actuator driving device for moving the head in the disk drive. The actuator driving device includes an actuator on which the head is mounted, and a VCM driving circuit for driving the actuator. The plant 720 generates a PES that corresponds to a position of the head on the disk each time a control signal is input while performing track following control in the servo controller 710.

In order to solve a disturbance ŵ estimated by multiplying a modeling inverse transfer function Gv⁻¹ between the input disturbance w and the servo output signal y by the PES, the disturbance inverse transfer function tool 730 applies a zero phase error tracking (ZPET) inverse method by using the PES of a previous period.

$${G}_{v} = \frac{P}{1 + CP} \qquad [ Equation 3 ]$$

Here, C is a transfer function of the servo controller 710 and P is a transfer function of the plant 720.

A transfer function Gv includes unstable zero and thus an inverse of the transfer function may not be directly obtained. In the exemplary embodiment, the ZPET inverse method of using the PES of a previous period is applied.

Firstly, it is assumed that the transfer function Gv from the input disturbance w to the servo output signal y of the plant 720 is represented by Equation 4.

$${G}_{v} ( {z}^{- 1} ) = \frac{{z}^{- d} {B}^{-} ( {z}^{- 1} ) {B}^{-} ( {z}^{- 1} )}{A ( {z}^{- 1} )} \qquad [ Equation 4 ]$$

Here, B⁺(z⁻¹) denotes stable zero and B⁻¹(z⁻¹) denotes unstable zero. In order to estimate a disturbance, a filter represented by Equation 5 is applied.

$${G}_{vi} ( {z}^{- 1} ) = \frac{A ( {z}^{- 1} ) {B}^{-} ( z )}{{{B}^{-} ( {z}^{- 1} ) [ {B}^{-} ( 1 ) ]}^{2}} \qquad [ Equation 5 ]$$

Then, a transfer function from the input disturbance w to the estimated disturbance ŵ may be represented by Equation 6.

$$\frac{\hat{w} ( k )}{w ( k )} = {G}_{w} ( {z}^{- 1} ) \times {G}_{w} ( {z}^{- 1} ) = {z}^{- 1} \frac{{B}^{-} ( {z}^{- 1} ) {B}^{-} ( z )}{{[ {B}^{-} ( 1 ) ]}^{2}} \qquad [ Equation 6 ]$$

Here, a relationship as in Equation 7 is established. Thus, the estimated disturbance has a zero phase error characteristic except for a time delay of d-step.

$$\frac{{B}^{-} ( {z}^{- 1} )}{{B}^{-} ( 1 )} = Re ( ω ) - Im ( ω ) , \frac{{B}^{-} ( z )}{{B}^{-} ( 1 )} = Re ( ω ) + Im ( ω ) \qquad [ Equation 7 ]$$

If a value of the input disturbance after d-step is already known, the time delay may be eliminated as in Equation 8.

$$\hat{w} ( k ) = \frac{{B}^{-} ( {z}^{- 1} ) {B}^{-} ( z )}{{[ {B}^{-} ( 1 ) ]}^{2}} {z}^{- d} w ( k + d ) \qquad [ Equation 8 ]$$

Since it is assumed that a periodic disturbance synchronized with disk rotation frequency is generated, the estimated disturbance ŵ may be obtained as in Equation 9 by using the servo output signal y obtained in a previous period.

$$\hat{w} ( k ) = \frac{A ( {z}^{- 1} ) {B}^{-} ( z )}{{{B}^{+} ( {z}^{- 1} ) [ {B}^{-} ( 1 ) ]}^{2}} y ( k + d ) \qquad [ Equation 9 ]$$

In the exemplary embodiment, when the periodic disturbance synchronized with the disk rotation frequency is detected in the disturbance detection mode, the PES of the previous period stored in a buffer memory is used to identify an input trajectory of a next step required to generate a feed-forward input. In order to efficiently use the buffer memory, previous period data by one rotation period is used and data at a position other than starting and end points of one rotation period is calculated by considering the starting and end points as continuous points based on the detected periodicity.

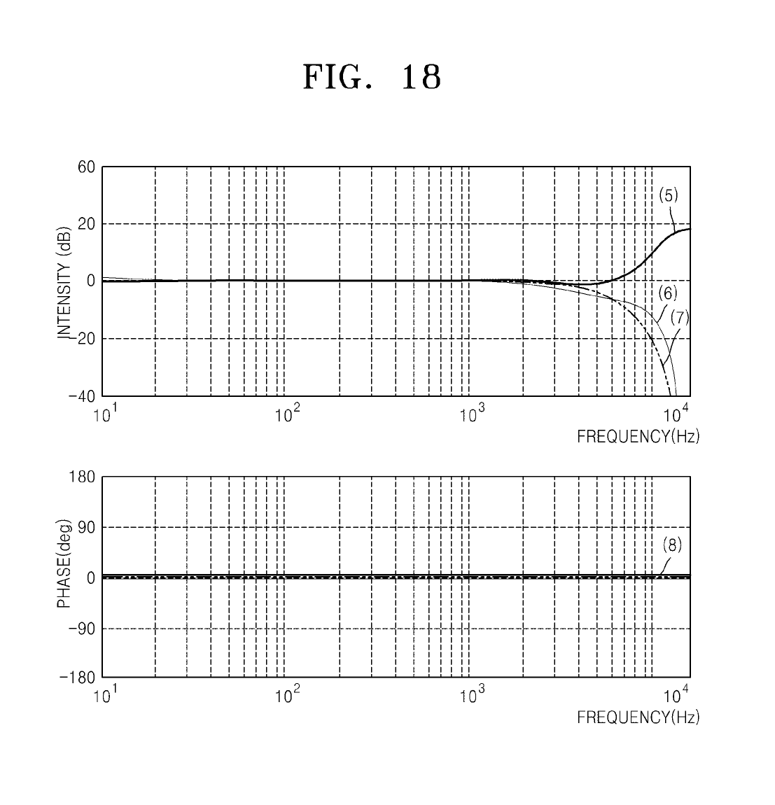

FIG. 17 is a graph showing frequency response against Gv and Gv⁻¹ (ZPET) obtained from an actual disk drive. In FIG. 17, trajectory (1) indicates a gain characteristic of Gv⁻¹(ZPET), trajectory (2) indicates a gain characteristic of Gv, trajectory (3) indicates a phase characteristic of Gv⁻¹(ZPET), and trajectory (4) indicates a phase characteristic of Gv

FIG. 18 is a graph showing frequency response against Gv*Gv⁻¹(ZPET) in an actual disk drive. In FIG. 18, trajectory (5) indicates a gain characteristic of Gv*Gv⁻¹(ZPET), trajectory (6) indicates a gain characteristic of Gv*Gv⁻¹(ZPET)*LPF, trajectory (7) indicates a phase characteristic of LPF, and trajectory (8) indicates a phase characteristic of Gv*Gv⁻¹(ZPET)*LPF.

Gv⁻¹ obtained by a ZPET method may not completely eliminate zeros of Gv and thus two functions are multiplied to amplify the magnitude of a frequency area as illustrated in FIG. 18. However, the system is poor in terms of stability and thus an additional low pass filter (LPF) is used. The LPF used herein may include a finite impulse response (FIR) filter to solve a stability problem due to addition of the filter and a phase delay is prevented from being generated. Here, data by one rotation period is used to calculate data at a position other than starting and end points of one rotation period by considering the starting and end points as continuous points based on the detected periodicity. Q(z), an output of the FIR LPF, may be represented by Equation 10.

$$Q ( z ) = \frac{\begin{matrix}{a}_{n} {z}^{n} + {a}_{n - 1} {z}^{n - 1} + … + \\ {a}_{0} + … + {a}_{n - 1} {z}^{- ( n - 1 )} + {a}_{n} {z}^{- n}\end{matrix}}{m} \qquad [ Equation 10 ]$$

Here, aₙ is a filter coefficient and m is a scaling constant for a unit gain.

FIG. 8 is a block diagram of a servo control system for generating a feed-forward input, according to another exemplary embodiment.

As illustrated in FIG. 8, the servo control system for generating a feed-forward input according to the current exemplary embodiment includes the servo controller 710, the plant 720, the summer 740, a plant inverse transfer function tool 750, and a subtractor 760.

The servo controller 710, the plant 720, and the summer 740 are described above with reference to FIG. 7 and thus a detailed description thereof will not be repeated.

A modeling inverse transfer function P⁻¹ of the plant 720 is obtained in the same manner as in obtaining of Gv⁻¹ described with reference to FIG. 7 and the PES that corresponds to the servo output signal y and a control signal u are received to estimate an input disturbance.

That is, the plant inverse transfer function tool 750 outputs the result obtained by multiplying the PES generated from the plant 720 by the modeling inverse transfer function P⁻¹ of the plant 720. Also, the subtractor 760 subtracts the control signal u from the result obtained by multiplying the PES by the modeling inverse transfer function P⁻¹, thereby calculating an estimated disturbance ŵ of a next period.

The method of generating a feed-forward input as in FIG. 8 facilitates obtaining of an inverse transfer function of a plant so as to reduce a calculated amount. However, since the control signal u is used, a size of a buffer memory increases.

Here, an apparatus for compensating for a disturbance according to an exemplary embodiment will be described in detail.

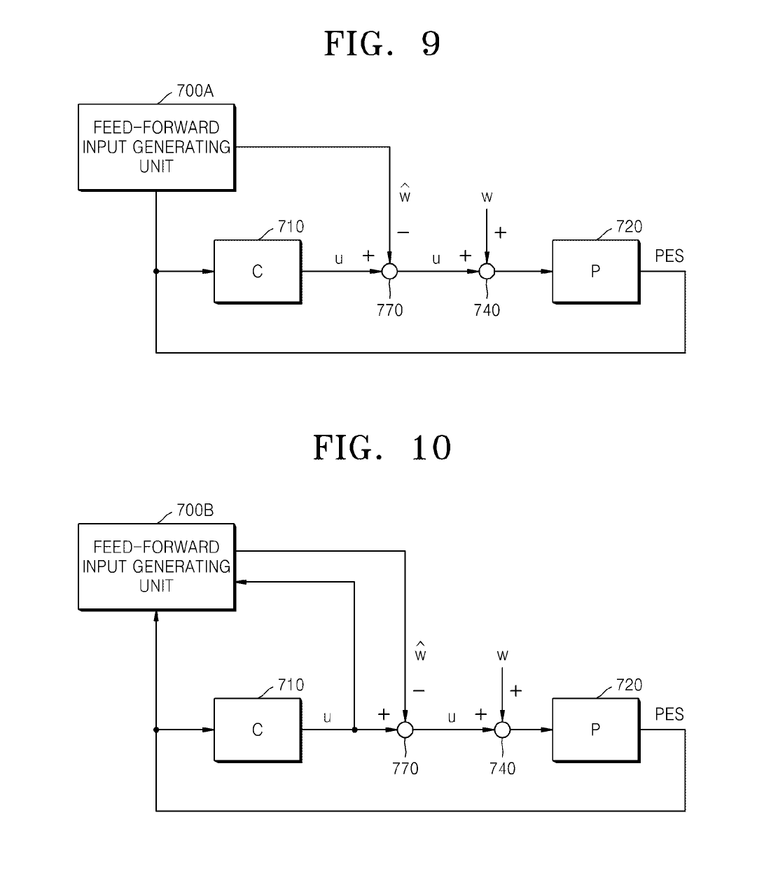

FIG. 9 is a circuit-block diagram of an apparatus for compensating for a disturbance, according to an exemplary embodiment. The apparatus for compensating for a disturbance illustrated in FIG. 9 may be designed to be included in the processor 110 of the data storage apparatus of FIG. 1 or the controller 430 of FIG. 4, or may be designed to have a separate circuit structure.

In the current exemplary embodiment, the apparatus for compensating for a disturbance is designed to be included in the processor 110 or the controller 430.

As illustrated in FIG. 9, the apparatus for compensating for a disturbance includes the servo controller 710, the plant 720, a feed-forward input generating unit 700a, the summer 740, and a subtractor 770.

Here, the summer 740 equivalently indicates that a disturbance w is applied to the plant 720 due to an external shock.

The servo controller 710 estimates position, speed, and bias values from the PES as the servo output signal y of the plant 720 and the previous control signal u(k−1) to perform track following control in the disk drive and outputs a next control signal u(k) by using the estimated position, speed, and the bias values.

The plant 720 is a device to be servo-controlled and may be an actuator driving device for moving the head in the disk drive. The actuator driving device includes an actuator on which the head is mounted, and a VCM driving circuit for driving the actuator. The plant 720 generates a PES that corresponds to a position of the head on the disk each time a control signal is input while performing track following control in the servo controller 710.

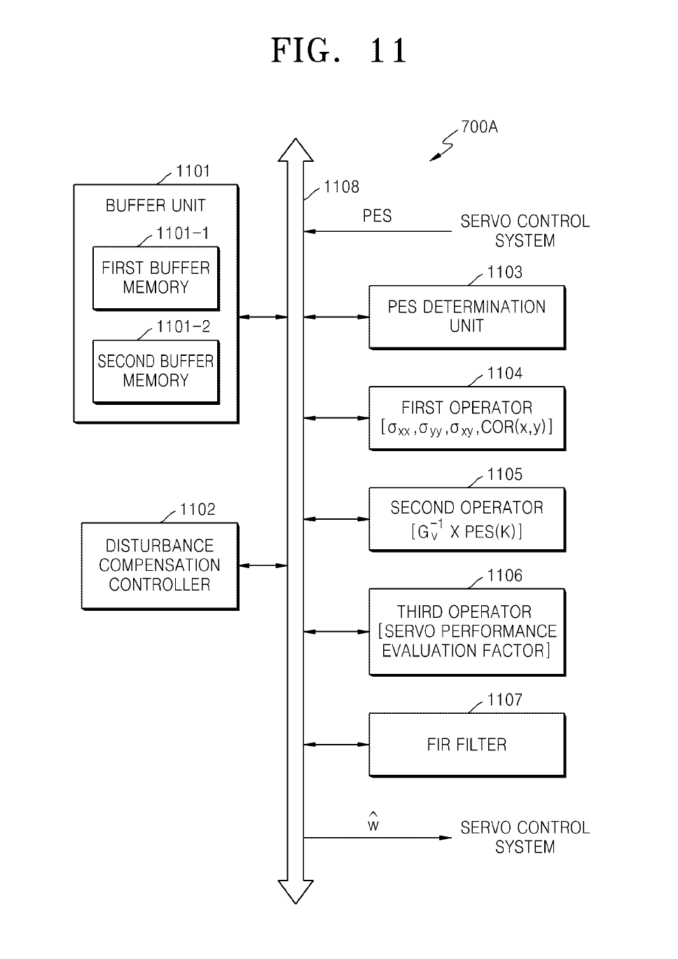

The feed-forward input generating unit 700A calculates the estimated disturbance ŵ of a next period by using the PES of a previous period in the disturbance detection mode, calculates a correlation coefficient of the PES in adjacent periods, and evaluates the calculated correlation coefficient. As a result of evaluation, when it is determined that a periodic external shock is applied to the plant 720, the calculated estimated disturbance ŵ is output to the subtractor 770. FIG. 11 is a block diagram of the feed-forward input generator 700A of FIG. 9. An operation of the feed-forward input generating unit 700A is described with reference to FIG. 11.

As illustrated in FIG. 11, the feed-forward input generating unit 700A according to the present exemplary embodiment includes a buffer unit 1101, a disturbance compensation controller 1102, a PES determination unit 1103, first, second, and third operators 1104, 1105, and 1106, an FIR filter 1107, and a bus 1108.

The buffer unit 1101 includes a first buffer memory 1101-1 for storing a PES for at least one period and a second buffer memory 1101-2 for storing the estimated disturbance. Here, the one period may be defined as one rotation of a disk. That is, the PES values generated during one rotation of the disk are stored in the first buffer memory 1101-1 and the estimated disturbance values corresponding to one rotation of the disk are stored in the second buffer memory 1101-2.

The disturbance compensation controller 1102 controls the buffer unit 1101 to store the PES for the one period in the first buffer memory 1101-1 in the disturbance detection mode.

Here, the disturbance detection mode may be designed to be performed in a retry mode or an idle mode. Also, for example, when the PES is abnormally detected in the retry mode, the disturbance detection mode is performed. More specifically, when the retry mode is performed for more than P times and the PES is abnormally detected for more than N times while the retry mode is performed for more than P times, the disturbance detection mode is performed. Also, the condition for performing the disturbance detection mode may be set differently from the above. Here, P and N are each a fixed number greater than or equal to 1, respectively, and are initially set values determined while designing the disk drive.

For example, when the retry mode is performed for more than P times and the PES is abnormally detected for more than N times while the retry mode is performed for more than P times, and the disk drive is designed to perform the disturbance detection mode, the disturbance compensation controller 1102 transmits a control signal for monitoring the PES to the PES determination unit 1103 in a read or write retry mode.

Then, the PES determination unit 1103 counts the number of times that the PES input in the read or write retry mode exceeds the threshold value TH1.

When the retry mode is performed for more than P times, the disturbance compensation controller 1102 temporarily stops the retry mode when the number of times counted in the PES determination unit 1103 exceeds N times while performing the retry mode for P times and controls the disk drive to perform the disturbance detection mode.

In the disturbance detection mode, the disturbance compensation controller 1102 controls the disk drive while performing a track following control to store a PES(k) generated during one rotation of the disk in a k^{th} period in the first buffer memory 1101-1 of the buffer unit 1101.

In the disturbance detection mode, the first operator 1104 calculates the variance σₓₓ for the PES generated during one rotation of the disk in a k^{th} period, calculates the variance for the PES(k+1) generated during one rotation of the disk in a k+1^{th} period, and calculates the covariance σ_{xy} for the PES in the k^{th} period stored in the first buffer memory 1101-1 and the PES in the k+1^{th} period as in Equation 2 above. Then, the first operator 1104 calculates the correlation coefficient COR (x, y) as in Equation 1.

In the disturbance detection mode, the first operator 1104 obtains the correlation coefficient COR (x, y) and the second operator 1105 calculates an estimated disturbance for generating a feed-forward input in order to compensate for a periodic disturbance synchronized with a rotation period of the disk. More specifically, the second operator 1105 generates the estimated disturbance ŵ by multiplying the modeling inverse transfer function Gv⁻¹ between the input disturbance w and the servo output signal y by the PES of the previous period stored in the first buffer memory 1101-1. Then, the disturbance compensation controller 1102 controls the disk drive to store the estimated disturbance ŵ generated from the second operator 1105 in the second buffer memory 1101-2 of the buffer unit 1101.

The disturbance compensation controller 1102 compares the correlation coefficient COR (x, y) calculated in the first operator 1104 with a threshold value M. As a result of comparison, when the correlation coefficient COR (x, y) is greater than the threshold value M, the disturbance compensation controller 1102 reads the estimated disturbance ŵ stored in the second buffer memory 1101-2 of the buffer unit 1101 and an LPF processes the read estimated disturbance ŵ in the FIR filter 1107. Then, the LPF processed estimated disturbance ŵ is output to the servo control system.

Due to such an operation of the feed-forward input generating unit 700A, the estimated disturbance ŵ as a feed-forward input output from the FIR filter 1107 is generated.

The third operator 1106 calculates servo performance evaluation factors before and after disturbance compensation. The servo performance evaluation factors may be, for example, a standard deviation or square mean of a PES.

The disturbance compensation controller 1102 compares the servo performance evaluation factors before and after disturbance compensation calculated in the third operator 1106 and as a result, may be designed to control the disk drive so as to stop a feed-forward input, in which control performance of the servo control system is not improved, and to retry generating of a feed-forward input.

Also, the disturbance compensation controller 1102 may be designed to control the disk drive so as to stop a feed-forward input, when a retry mode is not released after disturbance compensation or intensity of the PES increases, and to retry generating of a feed-forward input.

Referring back to FIG. 9, the estimated disturbance ŵ generated from the feed-forward input generating unit 700A as in FIG. 11 is input to the subtractor 770.

Accordingly, the subtractor 770 subtracts the estimated disturbance ŵ generated from the feed-forward input generating unit 700A from the control signal u generated from the servo controller 710 and applies the finally subtracted control signal to the plant 720.

As such, a disturbance synchronized with a rotation period of the disk due to a shock applied to the plant 720 may be previously estimated and thus may be compensated in a feed-forward method.

Here, an apparatus for compensating for a disturbance, according to another exemplary embodiment will be described in detail.

FIG. 10 is a circuit-block diagram of an apparatus for compensating for a disturbance, according to another exemplary embodiment. The apparatus for compensating for a disturbance illustrated in FIG. 10 may be designed to be included in the processor 110 of the data storage apparatus of FIG. 1 or the controller 430 of FIG. 4, or may be designed to have a separate circuit structure.

As illustrated in FIG. 10, the apparatus for compensating for a disturbance includes the servo controller 710, the plant 720, a feed-forward input generating unit 700b, the summer 740, and the subtractor 770.

The servo controller 710, the plant 720, the summer 740, and the subtractor 770 are described above with reference to FIG. 9 and thus a detailed description thereof will not be repeated. The feed-forward input generating unit 700b, which is not included in FIG. 9, is now described in detail.

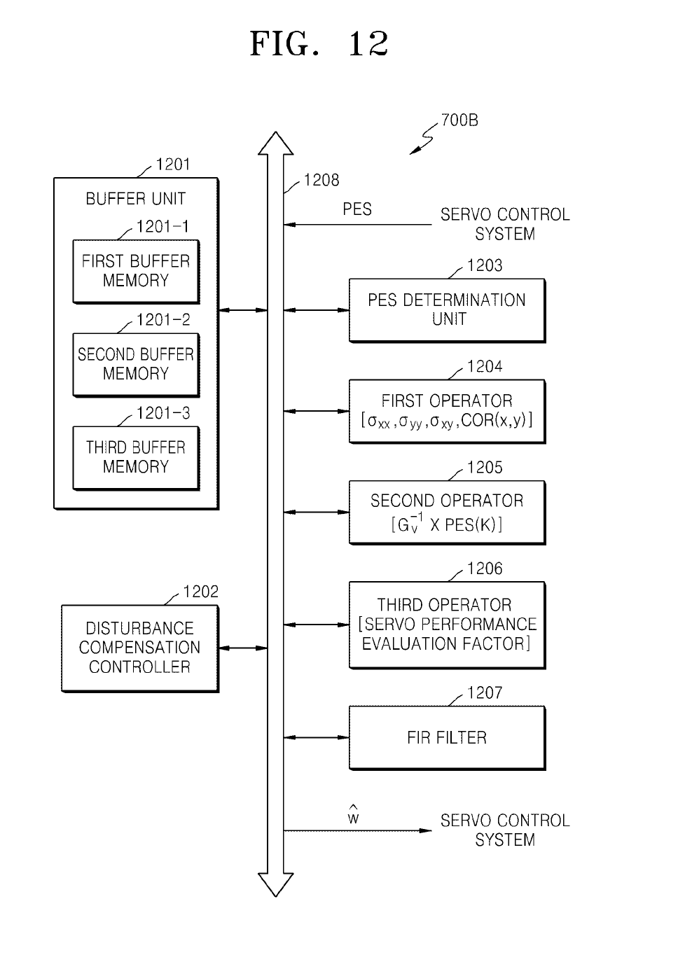

The feed-forward input generating unit 700B calculates the estimated disturbance ŵ of a next period by using the PES and the control signal u of a previous period in the disturbance detection mode, calculates a correlation coefficient of the PES in adjacent periods, and evaluates the calculated correlation coefficient. As a result of evaluation, when it is determined that a periodic external shock is applied to the plant 720, the calculated estimated disturbance ŵ is output to the subtractor 770. FIG. 12 is a block diagram of the feed-forward input generator 700B of FIG. 10. An operation of the feed-forward input generating unit 700b is described with reference to FIG. 12.

As illustrated in FIG. 12, the feed-forward input generating unit 700B according to the current exemplary embodiment includes a buffer unit 1201; a disturbance compensation controller 1202, a PES determination unit 1203, first, second, and third operators 1204, 1205, and 1206, a FIR filter 1207, and a bus 1208.

The buffer unit 1201 includes a first buffer memory 1201-1 for storing a PES for at least one period, a second buffer memory 1201-2 for storing a control signal u for at least one period, and a third buffer memory 1201-3 for storing an estimated disturbance for one period. Here, the one period may be defined as one rotation of a disk. That is, the PES values generated during one rotation of the disk are stored in the first buffer memory 1201-1, the control signal values u generated during one rotation of the disk are stored in the second buffer memory 1201-2, and the estimated disturbance values ŵ calculated during one rotation of the disk are stored in the third buffer memory 1201-3.

The disturbance compensation controller 1202 controls the buffer unit 1201 to store the PES and the control signal u for the one period in the first buffer memory 1201-1 and the second buffer memory 1201-2, respectively, in the disturbance detection mode.

For example, when the retry mode is performed for more than P times and the PES is abnormally detected for more than N times while the retry mode is performed for more than P times, the disk drive is designed to perform the disturbance detection mode, and the disturbance compensation controller 1202 transmits a control signal for monitoring the PES to the PES determination unit 1203 in a read or write retry mode.

Then, the PES determination unit 1203 counts the number of times that the PES input in the read or write retry mode exceeds the threshold value TH1.

When the retry mode is performed for more than P times, the disturbance compensation controller 1202 temporarily stops the retry mode when the number of times counted in the PES determination unit 1203 exceeds N times while performing the retry mode for more than P times and controls the disk drive to perform the disturbance detection mode.

In the disturbance detection mode, the disturbance compensation controller 1202 controls the disk drive while performing a track following control to store a PES(k) and a control signal u(k) generated during one rotation of the disk in a k^{th} period in the first buffer memory 1201-1 and the second buffer memory 1201-2 of the buffer unit 1101, respectively.

In the disturbance detection mode, the first operator 1204 calculates the variance σₓₓ for the PES generated during one rotation of the disk in the k^{th} period, calculates the variance σ_{yy} for the PES generated during one rotation of the disk in the k+1^{th} period, and calculates the covariance σ_{xy} for the PES in the k^{th} period stored in the first buffer memory 1201-1 and the PES in the k+1^{th} period as in Equation 2 above. Then, the first operator 1204 operates the correlation coefficient COR (x, y) as in Equation 1.

In the disturbance detection mode, the first operator 1204 obtains the correlation coefficient COR (x, y) and the second operator 1205 calculates an estimated disturbance for generating a feed-forward input in order to compensate for a periodic disturbance synchronized with a rotation period of the disk. More specifically, the second operator 1205 generates the estimated disturbance ŵ by multiplying the inverse transfer function P⁻¹ as in FIG. 8 by the PES of the previous period stored in the first buffer memory 1201-1 and by subtracting the control signal u of the previous period stored in the second buffer memory 1201-2 from the value obtained by the multiplying. Then, the disturbance compensation controller 1202 controls the disk drive to store the estimated disturbance ŵ generated from the second operator 1205 in the third buffer memory 1201-3 of the buffer unit 1201.

The disturbance compensation controller 1202 compares the correlation coefficient COR (x, y) calculated in the first operator 1204 with a threshold value M. As a result of comparison, when the correlation coefficient COR (x, y) is greater than the threshold value M, the disturbance compensation controller 1202 reads the estimated disturbance ŵ stored in the third buffer memory 1201-3 of the buffer unit 1201 and an LPF processes the read estimated disturbance ŵ in the FIR filter 1207. Then, the LPF processed estimated disturbance ŵ is output to the servo control system.

Due to such an operation of the feed-forward input generating unit 7006, the estimated disturbance ŵ as a feed-forward input output from the FIR filter 1207 is generated.

The third operator 1206 calculates servo performance evaluation factors before and after disturbance compensation. The servo performance evaluation factors may be, for example, a standard deviation or square mean of a PES.

The disturbance compensation controller 1202 compares the servo performance evaluation factors before and after disturbance compensation calculated in the third operator 1206 and as a result, may be designed to control the disk drive so as to stop a feed-forward input, in which control performance of the servo control system is not improved, and to retry generating of a feed-forward input.

Also, the disturbance compensation controller 1202 may be designed to control the disk drive so as to stop a feed-forward input, when a retry mode is not released after disturbance compensation or intensity of the PES increases, and to retry generating of a feed-forward input.

Referring back to FIG. 10, the estimated disturbance ŵ generated from the feed-forward input generating unit 700b as in FIG. 12 is input to the subtractor 770.

Accordingly, the subtractor 770 subtracts the estimated disturbance ŵ generated from the feed-forward input generating unit 700B from the control signal u generated from the servo controller 710 and applies the finally subtracted control signal to the plant 720.

As such, a disturbance synchronized with a rotation period of the disk due to a shock applied to the plant 720 may be previously estimated and thus may be compensated in a feed-forward method.

Next, the methods of compensating for a disturbance of FIGS. 13 through 16 according to exemplary embodiments performed by a control of the processor 110 of the data storage apparatus of FIG. 1 and the controller 430 of the disk drive of FIG. 4 are described. Hereinafter, for convenience of description, the methods are performed by a control of the controller 430. However, the exemplary embodiments are not limited thereto.

FIG. 13 is a flowchart illustrating a method of compensating for a disturbance, according to an embodiment of the inventive concept.

The controller 430 determines whether the disk drive satisfies the condition for performing the disturbance detection mode, in operation S1301. For example, the disturbance detection mode may be designed to be performed in a retry mode or an idle mode. Also, when the PES is abnormally detected in the retry mode, the disturbance detection mode is performed.

As a result of determination in operation S1301, when the condition for performing the disturbance detection mode is satisfied, the controller 430 calculates the estimated disturbance ŵ of a next period by using the correlation coefficient COR(x,y) in adjacent periods for a servo output signal generated from the servo control system of the disk drive and a servo output signal in a previous period, in operation S1302. Here, the servo control system may control a movement of the head in the disk drive and the servo control signal may include a PES. Also, one period may be determined as one rotation period of the disk.

The correlation coefficient COR (x, y) for the PES of the adjacent rotation periods may be calculated by using Equation 1 described above. Also, the estimated disturbance may be calculated by multiplying the PES of a previous period by an inverse transfer function between an input disturbance and a servo control signal as described in FIG. 7. As another method, the estimated disturbance may be calculated by subtracting the control signal of the servo control system from the result obtained by multiplying the PES of the previous period by the inverse transfer function of the plant targeted to be servo controlled in the servo control system as described in FIG. 8.

The correlation coefficient COR (x, y) calculated in operation S1302 is compared with the threshold value M, in operation S1303. The threshold value M is in the range of 0 to 1. If the threshold value M is set to be close to 1, correlation coefficient COR (x, y) may be determined as high correlation. Accordingly, the threshold value M may be in the range of 0.5 to 1.

As a result of comparison in operation S1303, if the correlation coefficient COR (x, y) is greater than the threshold value M, it may be determined as a periodic disturbance having high correlation and thus the estimated disturbance ŵ calculated in operation S1302 is feed-forwarded in the servo control system to compensate a disturbance to be generated in a next period, in operation S1304.

Then, the servo performance evaluation factors before and after disturbance compensation are calculated, in operation S1305. The servo performance evaluation factors may be, for example, a standard deviation or square mean of a PES.

Whether control performance of the servo control system is improved after being feed-forwarded compared with before being feed-forwarded is determined by using the servo performance evaluation factors calculated in operation S1305, in operation S1306. That is, when a standard deviation or square mean of the PES after being feed-forwarded is increased compared with that of the PES before being feed-forwarded, it may be determined that the control performance of the servo control system is not improved.

As a result of determination in operation S1306, when it is determined that the control performance of the servo control system after being feed-forwarded is not improved compared with before being feed-forwarded, feed-forwarding is stopped and operation 1302 is performed again. Then, the correlation coefficient and the estimated disturbance are recalculated.

FIG. 14 is a flowchart illustrating a method of compensating for a disturbance, according to another exemplary embodiment.

When the retry mode is performed for more than P times and the PES is abnormally detected for more than N times while the retry mode is performed for more than P times, the disturbance detection mode may be performed.

The controller 430 determines whether the number of times that the retry mode is continuously performed is more than P times, when a read or write error is generated in the disk drive, in operation S1401.

As a result of the determination in operation S1401, when the number of times that the retry mode is performed is more than P times, the PES is monitored while performing the retry mode for more than P times and whether the PES is abnormally detected for more than N times is determined, in operation S1402. That is, the number of times that the PES exceeds the threshold value TH1 is counted while performing the retry mode for more than P times and whether the counted numbers are more than N times is determined.

As a result of determination in operation S1402, when the PES is abnormally detected for more than N times, the controller 430 calculates the correlation coefficient COR(x,y) in adjacent periods for the servo output signal generated from the servo control system of the disk drive and the estimated disturbance ŵ of a next period by using a servo output signal of a previous period, in operation S1403. Here, the servo control system may control a movement of the head in the disk drive and the servo control signal may include a PES. Also, one period may be determined as one rotation period of the disk.

The correlation coefficient COR (x, y) for the PES of the adjacent rotation periods may be calculated by using Equation 1 described above. Also, the estimated disturbance may be calculated by multiplying the PES of a previous period by an inverse transfer function between an input disturbance and a servo control signal as described in FIG. 7. As another method, the estimated disturbance may be calculated by subtracting the control signal of the servo control system from the result obtained by multiplying the PES of the previous period by the inverse transfer function of the plant to be servo controlled in the servo control system as described in FIG. 8.

The correlation coefficient COR (x, y) calculated in operation S1403 is compared with the threshold value M, in operation S1404. Setting of the threshold value M is described with reference to FIG. 13 and thus the description thereof will not be repeated.

As a result of comparison in operation S1404, when the correlation coefficient COR (x, y) is greater than the threshold value M, it may be determined as a periodic disturbance having high correlation and thus the estimated disturbance ŵ calculated in operation S1403 is feed-forwarded in the servo control system to compensate a disturbance to be generated in a next period is compensated, in operation S1405.

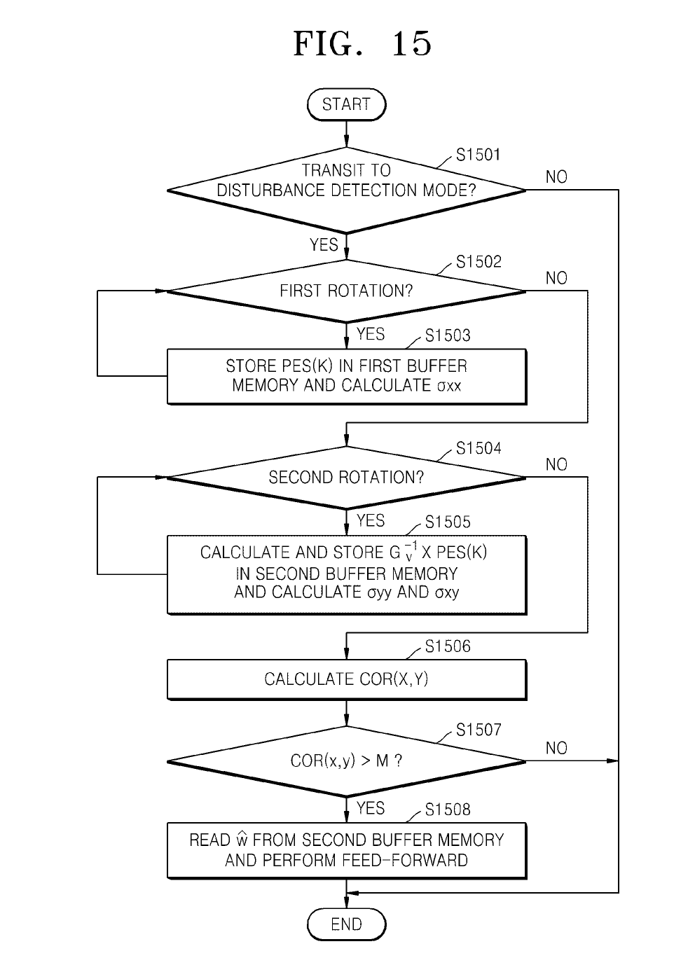

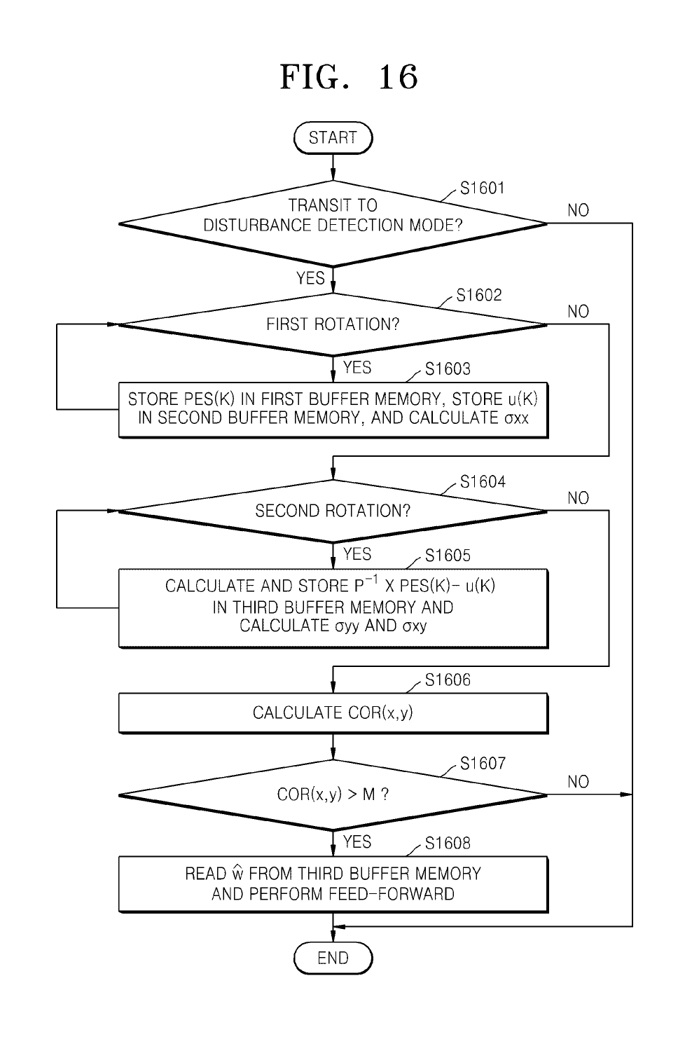

Then, a method of compensating for a disturbance according to an exemplary embodiment employing the method of generating a feed-forward input suggested in FIG. 7 is described with reference to FIG. 15.

Whether the disk drive transits to the disturbance detection mode is determined, in operation S1501. The disturbance detection mode may be designed to be performed in a retry mode or an idle mode. Also, when the PES is abnormally detected, in the retry mode, the disturbance detection mode is performed.

As a result of the determination in operation S1501, when the disk drive transits to the disturbance detection mode, whether the disk firstly rotates in a current track, in which a track following control is performed, is determined in operation S1502.

As a result of the determination in operation S1502, when the disk rotates a first time, the PES generated from the servo control system during the first rotation of the disk is stored in the first buffer memory 1101-1 and the variance σₓₓ for the PES generated during one rotation of the disk is calculated, in operation S1503.

Then, after the disk drive transits to the disturbance detection mode, whether the disk rotates a second time is determined, in operation S1504.

As a result of the determination in operation S1504, when the disk rotates a second time, the estimated disturbance ŵ is calculated by multiplying the modeled inverse transfer function Gv⁻¹ between the input disturbance and the servo output signal y described in FIG. 7 by the PES of the previous period stored in the first buffer memory 1101-1 during the second rotation so as to store the calculated estimated disturbance ŵ in the second buffer memory 1101-2, the variance σ_{yy} for the PES generated during the second rotation is calculated, and the covariance σ_{xy} for the PES generated during the first rotation stored in the first buffer memory 1101-1 and the PES generated during the second rotation is calculated as in Equation 2, in operation S1505.

Then, the correlation coefficient COR (x, y) is calculated as in Equation 1, in operation S1506.

Then, the correlation coefficient COR (x, y) operated is compared with the threshold value M, in operation S1507.

As a result of the comparison in operation S1507, when the correlation coefficient COR (x, y) is greater than the threshold value M, the correlation coefficient COR (x, y) may be determined as a periodic disturbance having high correlation and thus the estimated disturbance ŵ stored in the second buffer memory 1101-2 is read and is feed-forwarded to the servo control system so that a disturbance to be generated in a next period is compensated, in operation S1508.

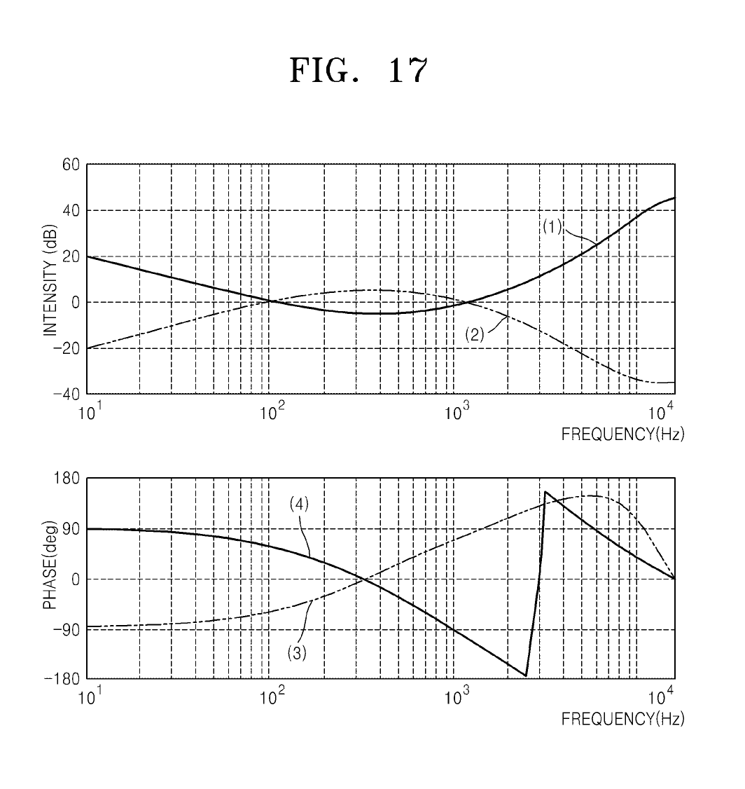

Then, a method of compensating for a disturbance according to an exemplary embodiment employing the method of generating a feed-forward input suggested in FIG. 8 is described with reference to FIG. 16.

Firstly, whether the disk drive transits to the disturbance detection mode is determined, in operation S1601.

As a result of the determination in operation S1601, when the disk drive transits to the disturbance detection mode, whether the disk rotates a first time in a current track, in which a track following control is performed, is determined in operation S1602.

As a result of the determination in operation S1602, when the disk rotates a first time, the PES and control signal generated from the servo control system during the first rotation of the disk are stored in the first buffer memory 1201-1 and the second buffer memory 1201-2, respectively, and the variance σₓₓ for the PES generated during one rotation of the disk is determined, in operation S1603.

Then, after the disk drive transits to the disturbance detection mode, whether the disk rotates a second time is determined, in operation S1604.

As a result of the determination in operation S1604, when the disk rotates a second time, the estimated disturbance ŵ is calculated by multiplying the inverse transfer function P⁻¹ of the plant described in FIG. 8 by the PES of the previous period stored in the first buffer memory 1201-1 during the second rotation and then by subtracting the control signal u of the previous period stored in the second buffer memory from the value obtained by the multiplying, the calculated estimated disturbance ŵ is stored in the third buffer memory 1201-3. The variance σ_{yy} for the PES generated during the second rotation is calculated, the covariance σ_{xy} for the PES generated during the first rotation is stored in the first buffer memory 1101-1 and the PES generated during the second rotation is calculated as in Equation 2, in operation S1605.

Then, the correlation coefficient COR (x, y) is calculated as in Equation 1, in operation S1606.

Then, the correlation coefficient COR (x, y) calculated is compared with the threshold value M, in operation S1607.

As a result of the comparison in operation S1607, when the correlation coefficient COR (x, y) is greater than the threshold value M, the correlation coefficient COR (x, y) may be determined as a periodic disturbance having high correlation and thus the estimated disturbance ŵ stored in the third buffer memory 1201-3 is read and is feed-forwarded to the servo control system to compensate a disturbance to be generated in a next period, in operation S1608.

According to one or more exemplary embodiments, the disturbance periodically generated from the disk drive by being synchronized with a disk rotation may be compensated in a feed-forward method.

While the inventive concept has been particularly shown and described with reference to exemplary embodiments thereof, it will be understood that various changes in form and details may be made therein without departing from the spirit and scope of the following claims.

1. A method of compensating for a disturbance, the method comprising:
calculating a correlation coefficient for a first signal which corresponds to a first period and a second period that is adjacent to the first period, and is generated by a servo control system;
determining, based on the calculated correlation coefficient, whether a periodic external shock is generated;
estimating a disturbance of a third period based on the calculated correlation coefficient; and
if it is determined that the periodic external shock is generated, compensating for the disturbance to be generated in the third period by feed-forwarding the estimated disturbance of the next period to the servo control system.

2. The method of claim 1, wherein the first signal comprises a position error signal.

3. The method of claim 1, wherein the servo control system controls a movement of a head of a disk drive.

4. The method of claim 1, wherein the calculating the correlation coefficient is performed in at least one of a retry mode and an idle mode.

5. The method of claim 1, wherein the calculating the correlation coefficient is performed when the first signal is abnormally detected in a retry mode of a disk drive.

6. The method of claim 1, wherein the correlation coefficient COR(x,y) is calculated according to
$$COR ( x , y ) = \frac{{σ}_{xy}}{\sqrt{{σ}_{xx} {σ}_{yy}}}$$
and wherein σ_{xy} is a covariance for the first signal in the first period and the second period, σₓₓ and σ_{yy} are variances for the first signal in the first period and the first signal in the second period, respectively; and
wherein x denotes a position error signal of the first period, and y denotes a position error signal of the second period.

7. The method of claim 1, wherein the estimating the disturbance comprises multiplying an inverse transfer function between an input disturbance and the first signal by the first signal of the first period and calculating an estimated disturbance of the third period.

8. The method of claim 1, wherein the estimating the disturbance comprises:
multiplying an inverse transfer function of a plant targeted to be controlled by the servo control system by the first signal of the first period to obtain a first value;
subtracting a control signal of the servo control system from the first value to obtain an estimated disturbance of the third period.

9. The method of claim 8, wherein the inverse transfer function is calculated after obtaining a transfer function having a zero phase error tracking (ZPET) characteristic and additionally using a finite impulse response (FIR) filter.

10. The method of claim 1, wherein the determining whether the periodic external shock is generated comprises calculating at least one of correlation coefficients corresponding to the first and second periods, average values of correlation coefficients corresponding to continuously adjacent periods, accumulation values of correlation coefficients corresponding to an initially set period, a maximum value of correlation coefficients, and a minimum value of correlation coefficients and determining that the periodic external shock is generated when the calculated value exceeds a threshold value.

11. The method of claim 1, further comprising:
performing an evaluation related to control performance of the servo control system before and after the feed-forwarding the estimated disturbance,
wherein, as a result of the evaluation, if the control performance of the servo control system after feed-forwarding the estimated disturbance is not improved compared with before the feed-forwarding, retrying the estimating of the disturbance.

12. The method of claim 11, wherein the performing the evaluation comprises:
determining whether at least one of a standard deviation and a square mean of the first signal after feed-forwarding is increased compared to at least one of a standard deviation and a square mean of the first signal before feed-forwarding.

13. An apparatus for compensating for a disturbance, the apparatus comprising:
a plant that generates a position error signal that corresponds to a final control signal;
a servo controller that generates a control signal that controls the plant based on an input signal;
a feed-forward input generating unit that calculates an estimated disturbance of a third period by using a position error signal of a first period in a disturbance detection mode, calculates a correlation coefficient of the position error signal corresponding to the first period and a second period that is adjacent to the first period, and outputs the calculated estimated disturbance if the calculated correlation coefficient exceeds a threshold value; and
a subtractor that subtracts the estimated disturbance output from the feed-forward input generating unit from the control signal generated by the servo controller to obtain a subtracted control signal, and applies the subtracted control signal to the plant.

14. The apparatus of claim 13, wherein the feed-forward input generating unit comprises:
a buffer unit that stores the position error signal of the first period;
a first operator that calculates the correlation coefficient of the position error signal corresponding to the first period and the second period and an input position error signal of the second period;
a second operator that calculates an estimated disturbance by multiplying an inverse transfer function between an input disturbance applied to the plant and a position error signal generated from the plant by the position error signal of the first period stored in the buffer unit; and
a disturbance compensation controller that stores a position error signal corresponding to at least one period in a disturbance detection mode and the calculated estimated disturbance in the buffer unit and outputs the estimated disturbance stored in the buffer unit to the subtractor, if the calculated correlation coefficient exceeds the threshold value.

15. The apparatus of claim 13, wherein the feed-forward input generating unit comprises:
a buffer unit that stores the position error signal of the first period;
a first operator that calculates the correlation coefficient of the position error signal of the first period stored in the buffer unit and an input position error signal of the second period;
a second operator that calculates an estimated disturbance by subtracting a control signal of the first period stored in the buffer unit from a value obtained by multiplying an inverse transfer function of the plant by the position error signal of the first period stored in the buffer unit; and
a disturbance compensation controller that stores a position error signal, a control signal corresponding to at least one period in a disturbance detection mode, and the calculated estimated disturbance in the buffer unit and outputs the estimated disturbance stored in the buffer unit to the subtractor, if the calculated correlation coefficient exceeds the threshold value.

16. The apparatus of claim 14, further comprising:
a finite impulse response (FIR) filter that low pass filters the estimated disturbance; and
wherein the inverse transfer function is realized as a transfer function having a zero phase error tracking (ZPET) characteristic.

17. The apparatus of claim 13, wherein the plant comprises an actuator driving device that moves a head of a disk drive.

18.-19. (canceled)

20. A disk drive comprising:
a disk that stores information;
a head that performs at least one of writing information to the disk or reading information from the disk;
an actuator driving device that moves a head on the disk according to an input signal and generates a position error signal that corresponds to a movement of the head;
a servo controller that generates a control signal that controls a movement of the head based on the position error signal;
a feed-forward input generating unit that calculates an estimated disturbance of a third period by using a position error signal of a first period in a disturbance detection mode, calculates a correlation coefficient of the position error signal corresponding to the first period and a second period that is adjacent to the first period, and outputs the calculated estimated disturbance if the calculated correlation coefficient exceeds a threshold value; and
a subtractor that subtracts the estimated disturbance output from the feed-forward input generating unit from the control signal generated from the servo controller to obtain a subtracted control signal, and applies the subtracted control signal to the actuator driving device.

21. The disk drive of claim 20, wherein the feed-forward input generating unit comprises:
a buffer unit that stores the position error signal of the first period;
a first operator that calculates the correlation coefficient of the position error signal corresponding to the first period and the second period and an input position error signal of the second period;
a second operator that calculates an estimated disturbance by multiplying an inverse transfer function between an input disturbance applied to the plant and a position error signal generated from the plant by the position error signal of the first period stored in the buffer unit; and
a disturbance compensation controller that stores a position error signal corresponding to at least one period in a disturbance detection mode and the estimated disturbance in the buffer unit and outputs the estimated disturbance stored in the buffer unit to the subtractor, if the calculated correlation coefficient exceeds the threshold value.

22. The disk drive of claim 20, wherein the feed-forward input generating unit comprises:
a buffer unit that stores the position error signal of the first period;
a first operator that calculates the correlation coefficient of the position error signal of the first period stored in the buffer unit and an input position error signal of the second period;
a second operator that calculates an estimated disturbance by subtracting a control signal of the first period stored in the buffer unit from a value obtained by multiplying an inverse transfer function of the actuator driving device by the position error signal of the first period stored in the buffer unit; and
a disturbance compensation controller that stores a position error signal, a control signal corresponding to at least one period in a disturbance detection mode, and the estimated disturbance in the buffer unit, and outputs the estimated disturbance stored in the buffer unit to the subtractor, if the correlation coefficient indicates a disturbance that is generated due to a periodic external shock.

23.-28. (canceled)
